(19) United States
(12) Patent Application Publication
(10) Pub. No.: US 2004/0245903 A1
(43) Pub. Date: Dec. 9, 2004

(54) Electron emitter, method for manufacturing the same, electro-optical device, and electronic apparatus

(76) Inventor: Toshimitsu Hirai, Chino-shi (JP)

Correspondence Address: HARNESS, DICKEY & PIERCE, P.L.C., P.O. BOX 828, BLOOMFIELD HILLS, MI, 48303, US

(21) Appl. No.: 10/809,203

(22) Filed: Mar. 25, 2004

(30) Foreign Application Priority Data
Mar. 26, 2003 (JP) 2003-085537
Feb. 6, 2004 (JP) 2004-031046

(51) Int. Cl. H01J 1/00; H01J 1/14; H01J 9/00; H01J 9/04

(52) U.S. Cl. 313/310; 313/311; 445/50; 445/51

(57) ABSTRACT

A method is provided for forming pairs of element electrodes and conductive layers between the element electrodes on a substrate. The method includes a step of forming banks surrounding electrode-forming regions for forming the element electrodes and conductive layer-forming regions for forming the conductive layers; a step of discharging first droplets toward the electrode-forming regions; and a step of discharging second droplets toward the conductive layer-forming regions.

### RELATED APPLICATIONS

This application claims priority to Japanese Patent Application Nos. 2003-085537 filed Mar. 26, 2003 and 2004-031046 filed Feb. 6, 2004 which are hereby expressly incorporated by reference herein in their entireties.

### BACKGROUND

1. Technical Field

The present invention relates to an electron emitter, a method for manufacturing electron emitters, an electro-optical device, and an electronic apparatus.

2. Background Art

Examples of cold-cathode electron emitters include a surface-conduction electron emitter disclosed in M. I. Elinson, Radio Eng. Electron Phys., 10, 1290 (1965) or the like. The surface-conduction electron emitter is based on a phenomenon that electrons are emitted by allowing currents to flow in parallel to the surfaces of a thin-film, placed on a substrate, having a small area. An electron emitter disclosed in Japanese Unexamined Patent Application Publication No. 2000-182513 includes an insulating substrate, a pair of element electrodes placed thereon, and a conductive thin-film placed between the element electrodes.

The electron emitter is prepared according to the following procedure: element electrodes are formed on a substrate by an ordinary process such as a vacuum vapor deposition process or a photolithographic process, conductive thin-films are formed by a dispersion coating process, and voltages are applied between the element electrodes, whereby sections for emitting electrons are formed.

In the above procedure, since a semiconductor process is principally used, there are the following problems: the number of manufacturing steps is large; electron emitters having a large area cannot be readily prepared by a current technique; special, expensive manufacturing equipment must be used; and manufacturing cost is high. In order to cope with such problems, the following technique is disclosed in Japanese Unexamined Patent Application Publication No. 2000-182513: droplets containing a conductive substance for forming the element electrodes are applied to the substrate by an ink-jet process, the resulting substrate is fired (heated), droplets containing a compound for forming the conductive thin-films in which the electron-emitting sections are placed are applied to the resulting substrate by an ink-jet process, and the resulting substrate is then fired, whereby the electron emitters are prepared.

When the droplets containing the compound for forming the conductive thin-films are applied to the substrate, the resulting droplets spread beyond predetermined regions. Therefore, the conductive thin-films obtained by firing are reduced in thickness and electron-emitting properties with high stability and reproducibility cannot be obtained. In order to cope with the problem, the following technique is disclosed in Japanese Unexamined Patent Application Publication No. 2000-182513: a hydrophobic coating is formed on the substrate.

In the known technique described above, there are problems below.

When a large amount of ink is applied onto a substrate, droplets cannot be readily prevented from being spread out in a uniform manner even if the hydrophobic coating is used. Therefore, the resulting droplets spread beyond predetermined regions and thin films obtained by firing are reduced in thickness; hence, electron-emitting properties with high stability and reproducibility cannot be obtained in some cases.

The present invention has been made to solve the above problem. It is an object of the present invention to provide an electron emitter having electron-emitting properties with high stability and reproducibility, a method for manufacturing electron emitters by placing droplets on predetermined areas, an electro-optical device, and an electronic apparatus.

### SUMMARY

In order to achieve the above object, the present invention has the configuration below.

A method for manufacturing electron emitters by providing pairs of element electrodes, and conductive layers connecting the element electrodes to each other on a substrate includes a step of forming banks surrounding electrode-forming regions for forming the element electrodes and conductive layer-forming regions for forming the conductive layers, a step of discharging first droplets toward the electrode-forming regions, and a step of discharging second droplets toward the conductive layer-forming regions.

In the above method, when the first droplets containing a material for forming the element electrodes are placed on the electrode-forming regions, the resulting first droplets can be prevented from spreading beyond predetermined areas. Furthermore, when the second droplets containing a material for forming the conductive layers are placed on the conductive layer-forming regions, the resulting second droplets can be prevented from spreading beyond predetermined areas. This is because the electrode-forming regions and the conductive layer-forming regions are surrounded by the banks. Thus, the element electrodes and conductive layers obtained by firing can be prevented from being decreased in thickness and the stability and reproducibility of properties thereof can therefore be prevented from being deteriorated.

The above method preferably further includes a step of lyophobing the banks.

If some of the discharged first or second droplets are placed on the banks, the resulting droplets are repelled by the banks because the banks are lyophobic, whereby the first or second droplets slide from the banks onto the electrode-forming regions or conductive layer-forming regions, respectively, surrounded by the banks. The resulting first or second droplets readily spread out in the electrode-forming regions or the conductive layer-forming regions, respectively, whereby the electrode-forming regions and the conductive layer-forming regions are uniformly filled with the first and second droplets, respectively.

In the method, the banks may be formed using a lyophobic material.

In this case, the lyophobing step can be eliminated, whereby manufacturing efficiency can be enhanced.

The method preferably further includes a step of lyophilizing at least one of the electrode-forming region and conductive layer-forming region on the substrate.

Since at least one of the electrode-forming region and conductive layer-forming region is lyophilic, the discharged first or second droplets readily spread out in the electrode-forming region or conductive layer-forming region, respectively, whereby the electrode-forming region and the conductive layer-forming region are uniformly filled with the first and second droplets, respectively.

The method may further include a step of removing the banks by an ashing process.

As a result, the banks surrounding the electrode-forming regions and conductive layer-forming regions can be removed from the substrate.

An electron emitter of the present invention is manufactured by the above method.

Therefore, components thereof obtained by firing can be prevented from being decreased in thickness; hence, the electron emitter has high stability and reproducibility.

An electron emitter of the present invention includes a substrate, a pair of element electrodes, a conductive layer for connecting the element electrodes each other, and a bank surrounding the element electrodes and the conductive layer, wherein the element electrodes, the conductive layer, and the bank are disposed on the substrate.

In the present invention, since droplets are placed onto a region surrounded by the bank when the element electrodes and the conductive layer are formed by a droplet-discharging process, the resulting droplets can be prevented from spreading beyond the region. Therefore, the element electrodes and the conductive layer can be prevented from being reduced in thickness; hence, the stability and reproducibility of the electron emitter can be prevented from being deteriorated.

An electro-optical device of the present invention includes the above electron emitter.

In the present invention, since the electron emitter has high stability and reproducibility, the electro-optical device also has high stability and reproducibility.

An electronic apparatus of the present invention includes the electro-optical device.

In the present invention, since the electro-optical device has high stability and reproducibility, the electronic apparatus also has high stability and reproducibility.

### BRIEF DESCRIPTION OF THE DRAWINGS

FIG. 1 is a schematic view showing an example of an electron emitter according to the present invention.

FIG. 2 is a schematic perspective view showing a film-forming apparatus.

FIG. 3 is a plan view showing a substrate having banks.

FIG. 4 is an illustration showing the principle of discharging a liquid material by a piezo method.

FIG. 5 is a schematic view showing a configuration of a vacuum processor.

FIG. 6 is a schematic view showing an example of an electron source having a simple matrix array.

FIG. 7 is a perspective view showing the appearance of heads diagonally arranged in a carriage.

FIG. 8 is a schematic view showing an example of a display panel functioning as an image-forming device.

FIG. 9(a) is an illustration showing an example of a mobile phone including an electronic apparatus according to the present invention, FIG. 9(b) is an illustration showing an example of a mobile information processor including the electronic apparatus, and FIG. 9(c) is an illustration showing an example of a wristwatch electronic system including the electronic apparatus.

### DETAILED DESCRIPTION

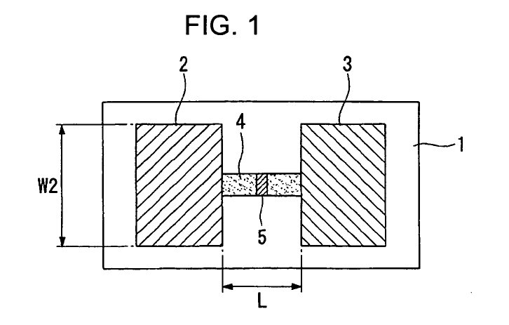

An electron emitter, a method for manufacturing electron emitters, an electro-optical device, and an electronic apparatus according to the present invention will now be described with reference to FIGS. 1 to 9.

A flat surface-conduction electron emitter will now be described with reference to FIG. 1.

FIG. 1 is a schematic plan view showing a basic configuration of the surface-conduction electron emitter according to an embodiment of the present invention.

With reference to FIG. 1, reference numeral 1 represents a substrate, reference numerals 2 and 3 each represent corresponding element electrodes, reference numeral 4 represents a conductive layer, and reference numeral 5 represents an electron-emitting section.

Examples of the substrate 1 include a quartz glass substrate, a glass substrate containing a small amount of impurities such as Na, a blue glass substrate, a glass substrate having a SiO₂ layer formed by a sputtering process, and a ceramic substrate containing alumina or the like.

The element electrodes 2 and 3 contain an ordinary conductor. Such a conductor can be selected from metals such as Ni, Cr, Au, Mo, W, P, Pt, Ti, Al, Cu, and Pd; alloys containing any one of the metals; a printing conductor containing glass, a metal oxide such as RuO₂, alloy such as Pd-Ag, and a metal such as Pd, As, Ag, or Au; a transparent conductor such as In₂O₃—SnO₂; and a semiconductor such as polysilicon.

The distance L between the element electrodes 2 and 3 is preferably several hundred nanometers to several hundred micrometers. Since a low voltage is preferably applied between the element electrodes 2 and 3 and the element electrodes 2 and 3 must be formed with high reproducibility, the distance L is more preferably several micrometers to several tens of micrometers. The length W2 of the element electrodes 2 and 3 is preferably several micrometers to several hundred micrometers because of the resistance and properties of the element electrodes 2 and 3 for emitting electrons. The thickness of element electrodes 2 and 3 is preferably several hundred angstroms to several micrometers. The dimensions of the element electrodes 2 and 3 and the distance L therebetween are more preferably determined depending on the thickness of the conductive layer 4.

The conductive layer 4 in which the electron-emitting section 5 is placed preferably includes fine particles so as to have superior properties of emitting electrons. The thickness of the conductive layer 4 is determined depending on the element electrodes 2 and 3 and electroforming conditions described below. The conductive layer 4 preferably has a thickness of several angstroms to several thousand angstroms and more preferably ten angstroms to 500 angstroms.

Examples of a material for forming the conductive layer 4 include metals such as Pd, Pt, Ru, Ag, Au, Ti, In, Cu, Cr, Fe, Zn, Sn, Ta, W, and Pb; oxides such as PdO, SnO₂, In₂O₃, PbO, and Sb₂O₃; borides such as HfB₂, ZrB₂, LaB₆, CeB₆, YB₄, and GdB₄; carbonides such as TiC, ZrC, HfC, TaC, SiC, and WC; nitrides such as TiN, ZrN, and HfN; semiconductors such as Si and Ge; and carbon.

The electron-emitting section 5 is placed in the conductive layer 4 and has cracks and high resistance. Properties and dimensions of the electron-emitting section 5 depend on the thickness, properties, and material of the conductive thin-film 4 and an electroforming technique described below.

The electron-emitting section 5 may contain conductive fine particles with a particle size of several angstroms to several tens of nanometers. The conductive fine particles contain part or all of chemical elements in a material for forming the conductive layer 4. The electron-emitting section 5 and the conductive layer 4 adjacent thereto may contain carbon or a carbon compound formed in an activation step described below.

A film-forming apparatus (droplet-discharging apparatus) for forming the element electrodes 2 and 3 and conductive layer 4 of the electron emitter will now be described.

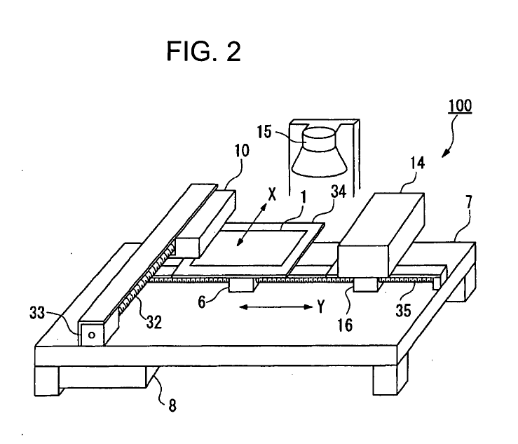

FIG. 2 is a schematic perspective view showing the film-forming apparatus according to this embodiment. With reference to FIG. 2, the film-forming apparatus 100 includes a liquid-discharging head 10 having nozzles, an X-direction guide shaft 32 for moving the liquid-discharging head 10 in the X direction, an X-direction driving motor 33 for turning the X-direction guide shaft 32, a support table 34 for supporting a substrate 1, a Y-direction guide shaft 35 for moving the support table 34 in the Y direction, a first Y-direction driving motor 6 for turning the Y-direction guide shaft 35, a second Y-direction driving motor 16, a cleaner section 14, a heater 15, a controller 8 for collectively controlling those components, and a base table 7. The X-direction guide shaft 32 and Y-direction guide shaft 35 are fixed on the base table 7. With reference to FIG. 2, the liquid-discharging head 10 extends in the direction perpendicular to the traveling direction of the substrate 1. The direction in which liquid-discharging head 10 extends may be varied such that the extending direction of the liquid-discharging head 10 and the traveling direction of the substrate 1 cross each other at a predetermined angle. The pitch between the nozzles can be adjusted by varying the angle. The distance between the substrate 1 and a plane on which the nozzles are arranged may be arbitrarily adjusted.

The liquid-discharging head 10 discharges a liquid material, containing a dispersion containing conductive fine particles, from the nozzles (discharge openings) and is fixed on the X-direction guide shaft 32. The X-direction driving motor 33, which is of a stepping type, turns X-direction guide shaft 32 when driving pulse signals are applied to the X-direction driving motor 33 from the controller 8. The liquid-discharging head 10 is moved in the X direction with respect to the base table 7 by the rotation of the X-direction guide shaft 32.

As described below, examples of a method for discharging liquid include various known methods such as a piezo method for discharging an ink material using piezoelectric elements and a bubble method for discharging liquid using bubbles generated by heating the liquid. The piezo method has an advantage that a change in material composition is not caused because the ink material is not heated.

The support table 34 is fixed on the Y-direction guide shaft 35, to which the first and second Y-direction driving motors 6 and 16 are connected. The first and second Y-direction driving motors 6 and 16 are of a stepping type or the like and turn the Y-direction guide shaft 35 when driving pulse signals are applied to the first and second Y-direction driving motors 6 and 16 from the controller 8. The support table 34 is moved in the Y direction with respect to the base table 7 by the rotation of the Y-direction guide shaft 35.

The cleaner section 14 cleans the liquid-discharging head 10 to prevent the nozzles from being plugged. The cleaner section 14 is moved along the Y-direction guide shaft 35 with the second Y-direction driving motor 16 during the cleaning operation.

The heater 15 includes a heating member such as an annealing lamp. The heater 15 heats the substrate 1 to evaporate and then dry the liquid material placed on the substrate 1, thereby converting the liquid material into conductive layers.

In the film-forming apparatus 100 of this embodiment, the substrate 1 is moved relatively to the liquid-discharging head 10 using the X-direction driving motor 33 and/or the first Y-direction driving motor 6 while the liquid-discharging head 10 discharges the liquid material, whereby the liquid material is placed on the substrate 1.

The amount of droplets discharged from the nozzles of the liquid-discharging head 10 is adjusted by a voltage applied to the piezoelectric elements from the controller 8.

The pitch between the droplets arranged on the substrate 1 is adjusted by varying the speed of the above relative movement and the frequency of discharging the liquid material from the liquid-discharging head 10. The discharging frequency depends on the frequency of a driving voltage applied to the piezoelectric elements.

A position to start discharging the droplets toward the substrate 1 is adjusted by varying the moving directions of the substrate 1 and liquid-discharging head 10 and by controlling the start timing of discharging the droplets from the liquid-discharging head 10 when the substrate 1 and liquid-discharging head 10 are moved.

A method for manufacturing electron emitters according to the present invention will now be described.

Step of Forming Banks

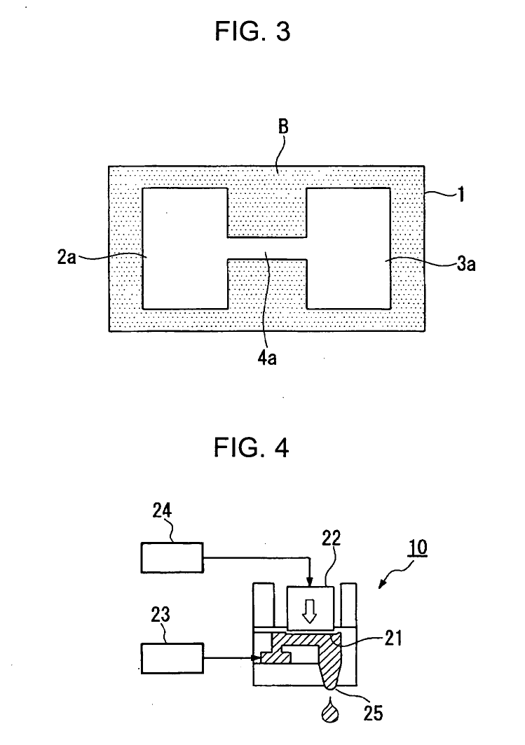

Banks B (see FIG. 3), which function as partitions, are formed by an arbitral process such as a lithographic process or a printing process. When the lithographic process is used, a coating containing an organic material is formed on the substrate 1 by a predetermined process such as a spin coating process, a spray coating process, a roll coating process, a dye coating process, or a dip coating process such that the thickness of the coating agree with the height (the thickness of the element electrodes 2 and 3 and the conductive layers 4) of the banks B. A resist layer is formed on the coating. A mask having a pattern corresponding to the banks B is placed on the resist layer, and the resulting resist layer is exposed and then developed, whereby the resist layer is formed to have the same pattern as the above. The coating is etched, whereby portions of the coating not covered with the mask are removed. Alternatively, the banks B (protrusions) may have a two or more layer structure including an inorganic layer and an organic layer disposed on.

Examples of the organic material for forming the banks B include a lyophobic material that repels liquid and an insulating material that can be readily lyophobed (teflonized®) by plasma treatment and patterned by a lithographic process and has a high affinity to the substrate 1. In particular, a polymer such as an acrylic resin, a polyimide resin, an olefin resin, or a melamine resin can be used.

In this embodiment, the substrate 1 has electrode-forming regions 2a and 3a (see FIG. 3) on which element electrodes 2 and 3 are each placed, respectively, and conductive layer-forming regions 4a (see FIG. 3) on which conductive layers 4 are each placed. Since the mask has a pattern corresponding to the electrode-forming regions 2a and 3a and conductive layer-forming regions 4a, the banks B each surrounding the electrode-forming regions 2a and 3a and conductive layer-forming regions 4a can be formed as shown in FIG. 3. The banks B preferably have a tapered shape, that is, the width of the banks B is narrowed upward because droplets of the liquid material are readily placed in the electrode-forming regions 2a and 3a and conductive layer-forming regions 4a.

Lyophilizing Step

When the substrate 1 is made of glass, the surface thereof has an affinity to a first material for forming the element electrodes 2 and 3 and a second material for forming the conductive layers 4. In this embodiment, in order to enhance the affinity and in order to readily remove a residue of the resist layer during the formation of the banks B, the substrate 1 is lyophilized. Examples of a process for lyophilizing the substrate 1 include a UV radiation process for applying UV rays to an object to lyophilize the object and an O₂ plasma process for treating an object in the atmosphere using oxygen. The O₂ plasma process is herein used.

In particular, O₂ plasma generated using plasma discharge electrodes is applied to the substrate 1. Conditions of the O₂ plasma treatment are as follows: for example, the plasma power ranges from 100 to 800 W, the oxygen flow rate ranges from 50 to 100 ml/min, the rate of transferring the substrate 1 with respect to the plasma discharge electrodes ranges from 0.5 to 10 mm/sec, and the substrate temperature ranges from 70 to 90° C.

Lyophobing Step

Subsequently, the banks B are lyophobed, thereby rendering the surface thereof lyophobic. Examples of a process for lyophobing the banks B include a plasma process (CF₄ plasma process) for treating an object in an air atmosphere using a tetrafluoromethane gas. Conditions of the CF₄ plasma treatment are as follows: for example, the plasma power ranges from 100 to 800 W, the flow rate of the tetrafluoromethane gas ranges from 50 to 100 ml/min, the rate of transferring the object with respect to plasma discharge electrodes ranges from 0.5 to 20 mm/sec, and the object temperature ranges from 70 to 90° C.

A treating gas is not limited to tetrafluoromethane and another fluorocarbon gas may be used.

Fluorine groups are introduced to the organic material contained in the banks B by the lyophobing treatment, whereby the banks B are rendered lyophobic. The treatment of lyophilizing the substrate 1 may be performed before the banks B are formed; however, the lyophilizing treatment is preferably performed after the banks B are formed because an acrylic resin and a polyimide resin are readily fluorinated (hydrophobed) when the resins are treated with O₂ plasma.

The treatment of lyophobing the banks B slightly affects the surface of the substrate 1 lyophilized in advance; however, the lyophilicity of the substrate 1, that is, the wettability of the substrate 1, is hardly deteriorated when the substrate 1 is made of glass or the like, because fluorine groups are not introduced to the substrate 1 by the lyophobing treatment.

The banks B may be formed using a hydrophobic material (a material having, for example, a fluorine group), whereby a step of hydrophobing the banks B is eliminated.

The banks B were lyophobed. Conditions of the treatment were as follows: the plasma power was 550 W, the flow rate of a tetrafluoromethane gas was 100 ml/min, and the rate of transferring the substrate 1 with respect to plasma discharge electrodes was 5 mm/sec. The resulting banks B had a contact angle of 64.9 degrees with respect to an organic silver compound (a diethyleneglycol dimethyl ether solvent) although the untreated banks B had a contact angle of ten degrees or less with respect to the compound. Furthermore, the treated banks B had a contact angle of 104.1 degrees with respect to pure water although the untreated banks B had a contact angle of 69.3 degrees with respect to pure water.

Step of Placing Material for Forming Element Electrodes

A first liquid material for forming the element electrodes 2 and 3 is applied onto the electrode-forming regions 2a and 3a lying on the substrate 1 by a droplet-discharging process. Examples of the droplet-discharging process include a charge control process, a pressure vibration process, an electro-mechanical conversion process, an electro-thermal conversion process, and an electrostatic attraction process. In the charge control process, charges are applied to a material with electrification electrodes, droplets of the material are discharged from nozzles, and the traveling direction of the droplets is controlled with deflecting electrodes. In the pressure vibration process, an ultra-high pressure of about 30 kg/cm² is applied to a material, whereby the material is moved to nozzle tips. The material is moved straight and then discharged from nozzles when a control voltage is not applied to the material. In contrast, when a control voltage is applied to the material, electrostatic repulsion is caused in the material, whereby the material is scattered and is not therefore discharged from the nozzles.

The electro-mechanical conversion process uses a phenomenon that piezo elements (piezoelectric elements) are deformed when they receive electrical pulse signals. In the electro-mechanical conversion process, a pressure is applied to spaces containing a liquid substance by the deformation of the piezo elements with a flexible substance placed between the spaces and piezo elements, and the liquid substance is pushed out of the spaces and then discharged from the nozzles. In the electro-thermal conversion process, bubbles are generated by rapidly heating a liquid substance with heaters each placed in spaces containing the liquid substance, which is discharged from nozzles by the pressure of the bubbles. In the electrostatic attraction process, a minute pressure is applied to spaces containing a liquid substance, menisci of the liquid substance are formed in nozzles, and an electrostatic attraction is applied to the liquid substance, whereby the liquid substance is discharged from the nozzles. Among others, the following processes can also be used in addition to the above processes: a process using a change in fluid viscosity due to an electric field and a process for allowing droplets to fly using discharge sparks.

In this embodiment, the droplet-discharging process used for the film-forming apparatus 100 has an advantage that the first liquid material is not wasted and the first liquid material can be precisely placed on desired areas at a desired amount. Droplets of the first liquid material (fluid) discharged by the droplet-discharging process each have a weight of, for example, 1 to 300 ng.

FIG. 4 is an illustration showing the principle of discharging a liquid material from the liquid-discharging head 10 by a piezo process.

With reference to FIG. 4, piezo elements 22 are each placed adjacent to corresponding liquid chambers 21 containing a liquid material (a first liquid material for forming the element electrodes 2 and 3 or a second liquid material for forming the conductive layers 4). The liquid chambers 21 are connected to a liquid material-feeding system 23 including a material tank for storing the liquid material, which is fed to the liquid chambers 21 through the liquid material-feeding system 23. The piezo elements 22 are each electrically connected to corresponding driving circuits 24, through which a voltage is applied to the piezo elements 22, whereby the piezo elements 22 are deformed. The liquid chambers 21 are deformed by the deformation of the piezo elements 22, whereby the liquid material is discharged from nozzles 25. In this operation, the strain of the piezo elements 22 can be controlled by varying the intensity of the applied voltage. The rate of straining the piezo elements 22 can be controlled by varying the frequency of the voltage applied. Since the liquid material is not heated when droplets of the material are discharged by the piezo process, there is an advantage in that a change in the material composition is hardly caused.

In this step, droplets (first droplets) of the first liquid material containing a substance for forming the element electrodes 2 and 3 are discharged from the liquid-discharging head 10,and then arranged on the electrode-forming regions 2a and 3a. In this operation, since the electrode-forming regions 2a and 3a are surrounded by the banks B, the first liquid material can be prevented from spreading beyond predetermined areas. Furthermore, since the banks B are lyophobic, the bank surfaces repel the discharged droplets if some of the droplets are placed on the banks B, whereby the droplets slide from the banks B onto the electrode-forming regions 2a and 3a. Since the electrode-forming regions 2a and 3a are lyophilic, the droplets placed in the electrode-forming regions 2a and 3a can be readily spread therein. Therefore, the electrode-forming regions 2a and 3a can be uniformly filled with the first liquid material.

The first liquid material, of which droplets are discharged, contains a first dispersion containing a first dispersion medium and first conductive fine particles, dispersed therein, for forming the element electrodes 2 and 3. In this embodiment, the organic silver compound (a diethyleneglycol dimethyl ether solvent) described above is used.

The first dispersion medium is not particularly limited, and any dispersion medium in which the first conductive fine particles can be dispersed and the aggregation of the dispersed particles is not caused can be used. Examples of the first dispersion medium include water; alcohols such as methanol, ethanol, propanol, and butanol; hydrocarbons such as n-heptane, n-octane, decane, dodecane, tetradecane, toluene, xylene, cymene, durene, indene, dipentene, tetrahydronaphthalene, decahydronaphthalene, and cyclohexylbenzene; ethers such as ethyleneglycol dimethyl ether, ethyleneglycol diethyl ether, ethyleneglycol methyl ethyl ether, diethyleneglycol dimethyl ether, diethyleneglycol diethyl ether, diethyleneglycol methyl ethyl ether, 1,2-dimethoxyethane, bis(2-methoxyethyl) ether, and p-dioxane; and polar compounds such as propylene carbonate, γ-butyrolactone, N-methyl-2-pyrrolidone, dimethylformamide, dimethyl sulfoxide, and cyclohexanone. In particular, water, the alcohols, the hydrocarbons, and the ethers are preferable in view of the dispersibility of the particles, the stability of the dispersion, and the ease of use for the droplet-discharging process (an ink-jet process), and water and the hydrocarbons are more preferable.

The first dispersion containing the first conductive fine particles preferably has a surface tension of 0.02 to 0.07 N/m. When the surface tension is less than 0.02 N/m, droplets of the first liquid material discharged from nozzles by the ink-jet process cannot fly in a straight line because the first liquid material has high wettability to the nozzle faces. In contrast, when the surface tension is more than 0.07 N/m, the amount of the discharged droplets and the timing of discharging the droplets cannot be readily controlled because the shape of the menisci formed at the nozzle tips is irregular. In order to adjust the surface tension, the first dispersion may further contain a minute amount of a fluorine, silicon, or nonion surface tension modifier as long as the contact angle of the first dispersion with respect to the substrate 1 is not greatly reduced. The nonion surface tension modifier is useful to enhance the wettability of the first liquid material to the substrate 1, useful to improve leveling properties of layers containing the first liquid material, and useful to prevent fine irregularities from arising in the layers. The surface tension modifier may contain an organic compound such as alcohol, ether, ester, or ketone according to needs.

The first dispersion preferably has a viscosity of 1 to 50 mPa.s. When the viscosity is less than 1 mPa.s, areas around the nozzles are soiled by the first liquid material when the droplets are discharged from the nozzles by the ink-jet process. When the viscosity is more than 50 mPa.s, the nozzle holes are frequently plugged with the first liquid material and the droplets cannot therefore be smoothly discharged.

Heat-Treating/Photo-Treating Step

In a heat-treating/photo-treating step, the first dispersion medium or a coating agent is removed from the droplets placed on the substrate 1. In order to enhance the electrical connection between the first conductive fine particles, the first dispersion medium is desirably be completely removed by heating the first liquid material, placed on the substrate 1, for forming the element electrodes 2 and 3. When the first conductive fine particles are coated with the coating agent, such as an organic compound, for enhancing the dispersibility of the first conductive fine particles, the coating agent must also be removed. Heat treatment and/or photo treatment is usually performed in an air atmosphere and may be performed in an atmosphere containing an inert gas such as nitrogen, argon, or helium. In the heat treatment and/or photo treatment, the temperature is properly determined depending on the boiling point (vapor pressure) of the first dispersion medium; the type and/or pressure of the atmosphere gas; the dispersibility and thermal behavior, including oxidizability, of the first conductive fine particles; the amount and presence or absence of the coating agent; and/or the upper limit temperature of the substrate 1.

In order to remove the coating agent containing an organic compound, the first liquid material must be heated at, for example, about 300° C. When the substrate 1 is made of plastic, the heating temperature is preferably within a range of room temperature to 100° C.

Examples of the heat treatment and/or photo treatment include ordinary heat treatment performed using a heater such as a hot plate or an electric furnace and treatment performed using a lamp-annealing system. A light source for the lamp-annealing system is not particularly limited, and the following lamp or laser can be used: an infrared lamp, a xenon lamp, a YAG laser, an argon laser, a carbon dioxide laser, or an excimer laser using XeF, XeCl, XeBr, KrF, KrCl, ArF, or ArCl. The light source usually has an output power of 10 to 5,000 W. In this embodiment, the output power is preferably within a range of 100 to 1,000 W.

According to the heat treatment and/or photo treatment, the first conductive fine particles are electrically connected to each other, whereby the first conductive fine particles are converted into conductive layers, that is, the element electrodes 2 and 3. The thickness of the element electrodes 2 and 3 can be increased by repeating the discharge of the droplets and the heat treatment.

Step of Placing Material for Forming Conductive Layers

After the element electrodes 2 and 3 are formed, droplets (second droplets) of a second liquid material for forming the conductive layers 4 are placed on the conductive layer-forming regions 4a on the substrate 1 by the droplet-discharging process described above. Since the conductive layer-forming regions 4a are surrounded by the banks B, the second liquid material can be prevented from spreading beyond predetermined areas. Furthermore, since the banks B are lyophobic, the bank surfaces repel the discharged droplets if some of the droplets are placed on the banks B, whereby the droplets slide from the banks B onto the conductive layer-forming regions 4a. Since the conductive layer-forming regions 4a are lyophilic, the droplets placed in the conductive layer-forming regions 4a can be readily spread therein. Therefore, the conductive layer-forming regions 4a can be uniformly filled with the first liquid material. If some of the droplets are placed on the element electrodes 2 and 3, the resulting droplets cause no problems.

The second liquid material, of which droplets are discharged, contain a second dispersion containing a second dispersion medium and second conductive fine particles, dispersed therein, for forming the conductive layers 4. The second dispersion medium may be the same as the first dispersion medium contained in the first liquid material for forming the element electrodes 2 and 3.

Heat-Treating/Photo-Treating Step

In this step, the second dispersion medium or the coating agent is removed from the droplets placed on the substrate 1 by heating the substrate 1 in the same manner as that for forming the element electrodes 2 and 3.

According to the heat treatment and/or photo treatment, the second conductive fine particles are electrically connected to each other, whereby the second conductive fine particles are converted into conductive layers, that is, the conductive layers 4. The thickness of the conductive layers 4 can be increased by repeating the discharge of the droplets and the heat treatment.

Ashing Step

In this step, the banks B surrounding the electrode-forming regions 2a and 3a and conductive layer-forming regions 4a are removed by an ashing process. Examples of the ashing process include a plasma ashing process and an ozone ashing process.

In the plasma ashing process, an oxygen plasma gas or the like is allowed to react with the banks B (resist), thereby vaporizing the banks B, that is, removing the banks B. Since the banks B are made of a solid substance consisting of carbon, oxygen, and hydrogen, the banks B chemically react with the oxygen plasma gas to produce CO₂, H₂O, and O₂. That is, the banks B are completely converted into those gases and therefore removed.

The principle of the ozone ashing process is the same as that of the plasma ashing process. O₃ (ozone) is converted into O⁺ (oxygen radical), which is a reactive gas, and the banks B are allowed to react with O⁺. The reaction between O⁺ and the banks B produces CO₂, H₂O, and O₂, whereby the banks B are completely converted into those gases and therefore removed.

Electroforming Step

In this step, an electroforming operation is performed. Electron-emitting sections 5 are each formed in the corresponding conductive layers 4 by applying voltages between the element electrodes 2 and 3 (see FIG. 1). In this operation, thermal energy is locally converged at portions of the conductive layers 4 and structural changes therefore occur in the resulting portions, whereby the electron-emitting sections 5 are each formed at the corresponding portions.

The waveform of voltages used in the electroforming operation preferably has a pulse shape in particular. Examples of a technique for applying such voltages include a technique for continuously applying voltages having a pulse waveform which is triangular or rectangular and of which the peak value is constant and a technique for applying voltages having a pulse waveform of which the peak value is increased.

The termination of the electroforming operation can be monitored by intermittently applying a low voltage to the conductive layers 4 and then measuring the current, the applied voltage being insufficient to cause partial breakages or deformation in the conductive layers 4. In particular, a voltage of about 0.1 V is applied to the conductive layers 4 and the current flowing in the conductive layers 4 is then measured, whereby the resistance is determined. When the resistance exceeds 1 MΩ, the electroforming operation is stopped.

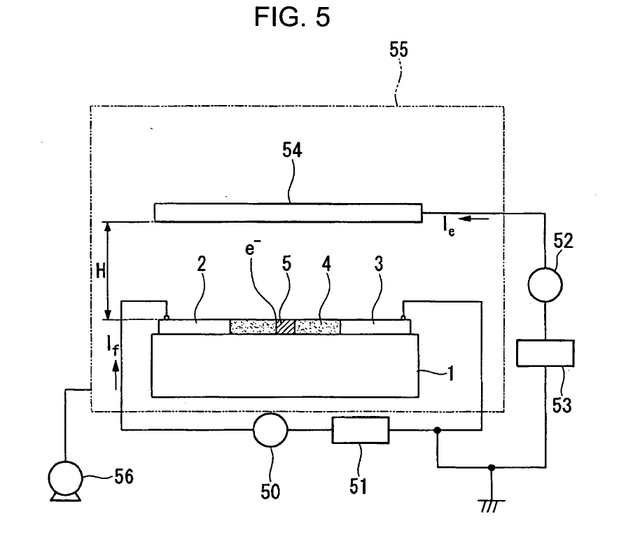

An electrical operation following the electroforming operation can be performed in, for example, a vacuum processor shown in FIG. 5. The vacuum processor also functions as a measurement/evaluation apparatus. In FIG. 5, sections that are the same as those shown in FIG. 1 have the same reference numerals as those shown in FIG. 1.

With reference to FIG. 5, reference numeral 55 represents a vacuum vessel and reference numeral 56 represents an evacuation pump. The electron emitters are placed in the vacuum vessel 55. Reference numeral 51 represents power supplies for applying element voltages V_{f} to the electron emitters, reference numeral 50 represents first ammeters for measuring element currents If flowing between the element electrodes 2 and 3, reference numeral 54 represents anodes for receiving emission currents Iₑ emitted from the electron-emitting sections 5, reference numeral 53 represents high-voltage power supplies for applying voltages to the anodes 54, and reference numeral 52 represents second ammeters for measuring the emission currents Iₑ emitted from the electron-emitting sections 5. Examples of measurement conditions are as follows: voltages applied to the anodes 54 are within a range of 1 to 10 kV and the distance between each anode 54 and electron emitter is within a range of 2 to 8 mm.

Instruments, such as vacuum gauges (not shown), necessary for measurement performed under vacuum conditions are placed in the vacuum vessel 55, and measurement and evaluation can therefore be performed under desired vacuum conditions. The evacuation pump 56 has a high vacuum system including a turbo pump, a rotary pump, or the like and an ultra-high high vacuum system including an ion pump or the like. All of the vacuum processor in which the electron emitters are placed can be heated with a heater (not shown).

Activating Step

The electron emitters processed in the electroforming step are then activated. In this step, pulse voltages are repeatedly applied between the element electrodes 2 and 3 in an atmosphere containing, for example, vapor of an organic substance in common with the electroforming step. According to the above operation, great changes are made in the element currents I_{f} and emission currents Iₑ.

An atmosphere, used in this step, containing the organic substance vapor can be formed using an organic gas that remains in the vacuum vessel 55 after the vacuum vessel 55 is evacuated with, for example, an oil diffusion pump or a rotary pump or can be formed by introducing a proper organic gas into the vacuum vessel 55 that has been fully evacuated with an oil-free ion pump. The preferable pressure of the organic substance vapor is properly selected according to needs because the pressure varies depending on a configuration of the electron emitters, the shape of the vacuum vessel 55, the species of the organic gas, and the like. Preferable examples of the organic substance include aliphatic hydrocarbons such as alkanes, alkenes, and alkynes; aromatic hydrocarbons; alcohols; aldehydes; ketones; amines; and organic acids such as phenols, carboxylic acids, and sulfonic acids. In particular, the following compounds are preferable: saturated hydrocarbons, such as methane, ethane, and propane, represented by the formula CₙH₂ₙ₊₂; unsaturated hydrocarbons, such as ethylene and propylene, represented by the formula CₙH₂ₙ; benzene; toluene; methanol; ethanol; formaldehyde; acetaldehyde; acetone; methyl ethyl ketone; methylamine; ethylamine; phenol; formic acid; acetic acid; and propionic acid.

According to the above operation, carbonaceous matter or carbon compounds derived from the organic substance contained in the atmosphere are deposited in cracks formed in the electroforming step and new cracks are formed in the resulting carbonaceous matter or carbon compounds, whereby great changes are further made in the element currents I_{f} and emission currents Iₑ.

Examples of the carbonaceous matter or carbon compounds include graphite, amorphous carbon, and a mixture of amorphous carbon and microcrystalline graphite. Examples of graphite includes HOPG having a substantially complete crystal structure, PG having a grain size of about 20 nm and a slightly defective crystal structure, and GC having a grain size of about 2 nm and a more defective crystal structure. Layers of the deposited carbonaceous matter or carbon compounds preferably have a thickness of 50 nm or less and more preferably 30 nm or less.

The termination of the activating operation can be determined by measuring the element currents I_{f} and emission currents I ₑ.

Stabilizing Step

The electron emitters processed in the above steps are preferably stabilized. In this step, the organic substance is removed from the vacuum vessel 55. A vacuum evacuator for evacuating the vacuum vessel 55 is preferably free of oil so as to prevent oil mist, generated from the vacuum evacuator, from affecting properties of the electron emitters. Examples of the vacuum evacuator include a sorption pump and an ion pump.

In order to prevent the above carbonaceous matter or carbon compounds from being excessively deposited, the partial pressure of the organic substance in the vacuum vessel 55 is preferably 1.3×10⁻⁶ Pa and more preferably 1.3×10⁻⁸ Pa. When the vacuum vessel 55 is evacuated, the vacuum vessel 55 is preferably heated because organic molecules adsorbed on the electron emitters can be readily removed. The heating temperature is preferably 80 to 250° C. and more preferably 150 to 250° C. The heating time is preferably long. The pressure in the vacuum vessel 55 is preferably low, that is, 1.3×10⁻⁵ Pa and more preferably 1.3×10⁻⁶ Pa. Conditions of this step are not limited to the above and may be properly determined depending on the size and shape of the vacuum vessel 55, a configuration of the electron emitters, and the like.

Conditions at the end of the stabilizing operation are preferably maintained until the stabilized electron emitters are driven, and conditions for driving the electron emitters are not limited to the above. If the organic substance is sufficiently removed, stable properties can be obtained although the pressure is slightly increased. The carbonaceous matter or carbon compounds can be prevented from being excessively deposited by selecting such vacuum conditions, whereby the element currents I_{f} and emission currents Iₑ are stabilized.

Basic properties of an electron emitter, prepared by the above procedure, according to the present invention will now be described.

According to the present invention, the electron emitter has the three characteristics with respect to emission current Iₑ as described below.

(I) The emission current Iₑ of the electron emitter is sharply increased when a voltage greater than a threshold value is applied to the electron emitter. In contrast, the emission current Iₑ is hardly detected when a voltage less than the threshold value is applied thereto. That is, the electron emitter functions as a nonlinear element having a clear threshold voltage with respect to emission current Iₑ.

(II) The emission current Iₑ is simply in proportion to the element voltage V_{f} and can therefore be controlled by varying the element voltage V_{f}.

(III) The amount of emitted electrons captured by the anodes 54 (see FIG. 5) depends on the time of applying an element voltage V_{f} to the electron emitter. That is, the amount of charges received by the anodes 54 can be controlled by varying the time of applying an element voltage V_{f} thereto.

As described above, in the electron emitter, properties of emitting electrons can be readily controlled by varying input signals. According to those properties, the electron emitter can be used in various applications such as electron sources including a plurality of electron emitters and image-forming devices.

As described above, in this embodiment, since droplets are placed on the electrode-forming regions 2a and 3a and conductive layer-forming regions 4a surrounded by the banks B, the droplets can be prevented from spreading beyond predetermined areas if a large amount of the droplets are discharged from nozzles. Therefore, the following problem can be prevented: the spread of the droplets causes a decrease in the thickness of layers obtained by heating the resulting droplets and the stability and reproducibility of properties of the electron emitter are therefore deteriorated. Furthermore, in this embodiment, the banks B are lyophobic. Therefore, if some of the discharged droplets are placed on the banks B, the resulting droplets can be allowed to slide from the banks B onto the electrode-forming regions 2a and 3a and the conductive layer-forming regions 4a. In this embodiment, the electrode-forming regions 2a and 3a and the conductive layer-forming regions 4a are lyophilic. Therefore, the discharged droplets can be readily spread in the electrode-forming regions 2a and 3a and the conductive layer-forming regions 4a, whereby the first and second liquid materials can be uniformly applied onto the electrode-forming regions 2a and 3a and conductive layer-forming regions 4a, respectively. Thus, the electrode-forming regions 2a and 3a and the conductive layer-forming regions 4a have a uniform thickness.

Applications of an electron emitter according to the present invention will now be described. An electro-optical device according to the present invention includes a substrate and a plurality of electron emitters placed thereon. Examples of the electro-optical device include an electron source and an image-forming device.

The electron emitters may be arranged in various patterns. For example, a large number of the electron emitters are arranged as follows: the electron emitters arranged in rows are connected to each other in series and ends of the rows are connected to each other in parallel, whereby a ladder array is formed. In the ladder array, control electrodes (referred to as grids) are arranged in the direction (referred to as a column direction) perpendicular to the direction (referred to as a row direction) of the rows and placed above the electron emitters. Electrons emitted from the electron emitters are controlled with the control electrodes. On the other hand, a plurality of the electron emitters may be arranged as follows: the electron emitters are arranged in the X direction and the Y direction, that is, the electron emitters are arranged in a matrix, one of electrodes of each electron emitter is connected to each wire for connecting the electron emitters arranged in the X direction, and the other one is connected to each wire for connecting the electron emitters arranged in the Y direction. This array is referred to as a simple matrix array, which is described below in detail.

An electron emitter of the present invention has the three characteristics described above. In one of the characteristics, electrons emitted from the electron emitter, which is of a surface conduction type, can be controlled by varying the peak value and width of waveforms of pulse voltages applied between element electrodes when the voltages are greater than a threshold value. In contrast, such electrons are hardly emitted when the voltages are less than the threshold value. According to that characteristic, in an array of a large number of the electron emitters, some of the electron emitters are selected and electrons emitted from the resulting electron emitters can be controlled depending on input signals by individually applying pulse voltages to the electron emitters.

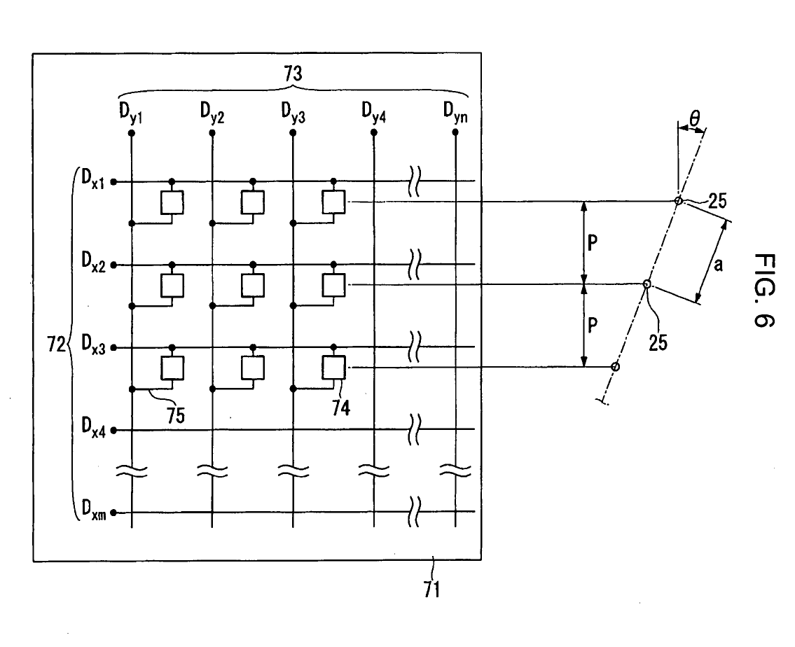

An electron source substrate including a plurality of electron emitters according to the present invention will now be described based on the above principle with reference to FIG. 6. With reference to FIG. 6, reference numeral 71 represents the electron source substrate, reference numeral 72 represents first wires extending in the X direction, reference numeral 73 represents second wires extending in the Y direction, reference numeral 74 represents the electron emitters, and reference numeral 75 represents connecting wires.

The first wires 72 are each represented by Dₓ₁, Dₓ₂, . . . , and Dₓₘ, that is, the number of the first wires 72 is m, wherein m represents a positive integer. The first wires 72 are made of a conductive metal and can be formed by a vacuum vapor deposition process, a printing process, a sputtering process, or a droplet-discharging process. A material for forming the first wires 72 and the thickness and width of the first wires 72 are properly determined. The second wires 73 each represented by D_{y1}, D_{y2}, . . . , and D_{yn}, that is, the number of the second wires 73 is n, wherein n represents a positive integer. The second wires 73 are formed by the same method as that for forming the first wires 72. An interlayer insulating layer, which is not shown, is placed between a layer including the first wires 72 and another layer including the second wires 73, whereby the first wires 72 are electrically insulated from the second wires 73. The interlayer insulating layer is made of SiO₂ and formed by a vacuum vapor deposition process, a printing process, or a sputtering process. The interlayer insulating layer has a predetermined shape and lies over the electron source substrate 71 having the first wires 72 thereon or lies above a region of the electron source substrate 71. For the interlayer insulating layer, the thickness, a material, and a preparing process are properly selected such that the interlayer insulating layer can endure potential differences at intersections of the first and second wires 72 and 73. The first and second wires 72 and 73 are routed outside and ends thereof function as external terminals.

Each electron emitter 74 includes a pair of element electrodes (not shown). One of the element electrodes is electrically connected to one of the first wires 72 with each connecting wire 75 made of a conductive metal and the other one is electrically connected to one of the second wires 73 with the connecting wire 75. A material for forming the first wires 72 may be the same as or different from that for forming the second wires 73 or may contain the same chemical element as that contained in a material forming the second wires 73. A material for forming the connecting wires 75 may be the same as or different from that for forming the element electrodes or may contain the same chemical element as that contained in a material forming the element electrodes. Those materials are selected from the examples of the material for forming the element electrodes 2 and 3 described above. When the element electrodes and the first and second wires 72 and 73 contain the same material, the first and second wires 72 and 73, which are connected to the element electrodes, function as parts of the element electrodes.

The first wires 72 are connected to a scanning signal-applying unit (not shown) for applying scanning signals, for selecting a row of the electron emitters 74 arranged in the X direction, to the first wires 72. On the other hand, the second wires 73 are connected to a modulating signal generator (not shown) for generating modulating signals for controlling the electron emitters 74 arranged in a column extending in the Y direction depending on input signals. A driving voltage applied to each electron emitter 74 corresponds to a difference in voltage between each scanning signal and modulating signal applied to the electron emitter 74.

In the above configuration, the electron emitters 74 can be independently driven using a simple matrix wiring scheme.

When the electron emitters 74 arranged in a matrix as shown in FIG. 6 are formed by a droplet-discharging process, the pitch between a plurality of nozzles 25 placed on a droplet-discharging head does not necessary agree with the pitch between the electron emitters 74. Therefore, in this embodiment, in order to allow the nozzle pitch with the emitter pitch, the droplet-discharging head is moved in such a manner that the direction in which the head is moved makes a predetermined angle of θ degree with the direction (hereinafter referred to as a non-scanning direction) perpendicular to the scanning direction.

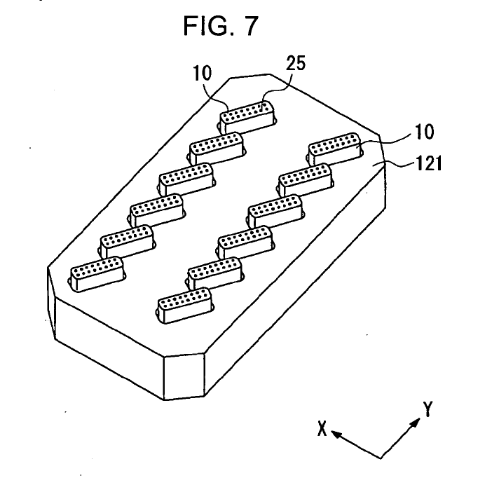

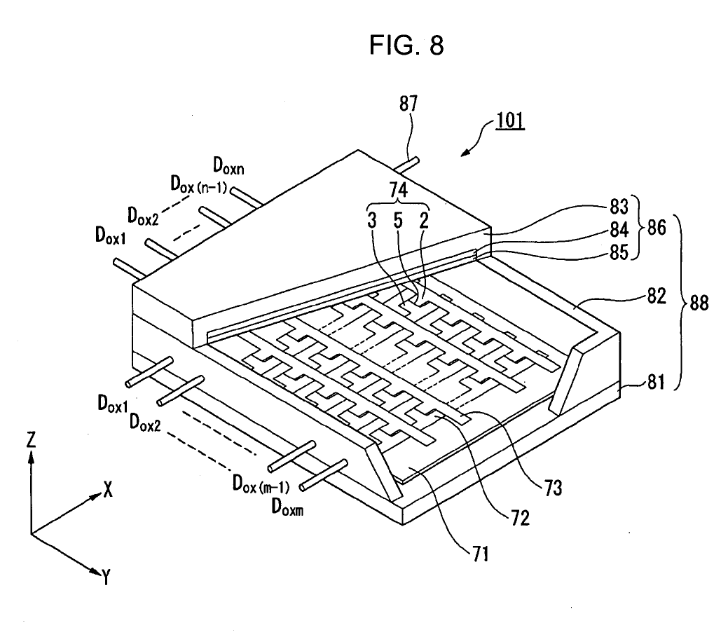

For example, when pitch P between the electron emitters 74 arranged in the non-scanning direction does not agree with pitch a between the nozzles 25, the head is turned about the Z axis with an angle of θ degree that satisfies the equation P=a×cos θ, whereby pitch P is relatively adjusted to pitch a. In order to tilt the head, a unit for turning the liquid-discharging head 10 shown in FIG. 2 about the Z axis may be used. Alternatively, a carriage 121, shown in FIG. 7, having heads 10 may be used. The heads 10 are diagonally arranged such that pitch P is relatively adjusted to pitch a.

According to the above configuration, there are no useless nozzles that cannot be used to discharge droplets because of the difference in pitch. Therefore, the productivity can be increased.

An example of an image-forming device including an electron source having the above simple matrix array will now be described with reference to FIG. 8. FIG. 8 is a schematic view showing a display panel 101 functioning as such an image-forming device.

With reference to FIG. 8, reference numeral 71 represents an electron source substrate including a plurality of electron emitters, reference numeral 81 represents a rear plate on which the electron source substrate 71 is fixed, reference numeral 82 represents a support frame, reference numeral 83 represents a glass substrate, reference numeral 84 represents a fluorescent screen, reference numeral 85 represents a metal back, reference numeral 86 represents a face plate, and reference numeral 88 represents an envelope. The face plate 86 includes the glass substrate 83, the fluorescent screen 84, and the metal back 85 disposed in that order. The support frame 82 is placed between the rear plate 81 and the face plate 86 and joined thereto with frit glass or the like. The envelope 88 has been fired at 400 to 500° C. for 10 minutes or more in an air or nitrogen atmosphere and is therefore sealed.

Reference numeral 74 represents electron emitters similar to the surface-conduction electron emitter shown in FIG. 1. Reference numeral 72 represents first wires, each connected to one of a pair of element electrodes connected to each electron emitter 74, extending in the X direction and reference numeral 73 represents second wires, each connected to the other one, extending in the Y direction. The envelope 88 includes the face plate 86, the support frame 82, and the rear plate 81, as described above. Since the rear plate 81 is principally used to compensate the strength of the electron source substrate 71, the rear plate 81 need not be used when the electron source substrate 71 has a sufficient strength. That is, the support frame 82 may be directly joined to the electron source substrate 71. In this case, the face plate 86, support frame 82, and electron source substrate 71 form the envelope 88. On the other hand, a supporting plate (not shown) functioning as a spacer may be placed between the face plate 86 and the rear plate 81, whereby the envelope 88 is allowed to have a strength sufficient to endure the atmospheric pressure.

The fluorescent screen 84 may include a single fluorescent material when the fluorescent screen 84 is used to display a monochrome image. In order to display a color image, the fluorescent screen 84 includes color fluorescent materials (not shown) and may further include a black conductor (not shown), referred to as a black stripe or a black matrix, depending on the arrangement of the color fluorescent materials. The objects of using the black conductor are as follows: color mixing is prevented by covering boundaries between the color fluorescent materials, which correspond to the three primary colors that are necessary to display a color image, with portions of the black conductor, and a decrease in contrast due to the reflection of external light is prevented from arising in the fluorescent screen 84. Examples of a material for forming the black conductor include an ordinary material principally containing graphite and a conductive material that hardly transmits and reflects light.

The single fluorescent material or color fluorescent materials can be provided on the glass substrate 83 by a precipitation process, a printing process, or the like whether the fluorescent screen 84 is used to display a monochrome image or a color image. The metal back 85 is usually placed under the fluorescent screen 84.

The objects of using the metal back 85 are as follows: the brightness is enhanced by reflecting light, emitted downward from the single fluorescent material or color fluorescent materials, toward the face plate 86; the metal back 85 is allowed to function as an electrode for applying a voltage, for accelerating an electron beam, to the single fluorescent material or color fluorescent materials; and the single fluorescent material or color fluorescent materials are prevented from being damaged by the collision of anions generated in the envelope 88. After the fluorescent screen 84 is prepared, the lower face of the fluorescent screen 84 is smoothed (this operation is usually referred to as “filming”) and Al is deposited on the resulting lower face by vacuum vapor deposition or the like, whereby the metal back 85 is prepared.

In order to enhance the conductivity of the fluorescent screen 84, a transparent electrode (not shown) may be placed on the upper face of the fluorescent screen 84. When the display panel 101 is used to display a color image, the color fluorescent materials must be each precisely aligned with the corresponding electron emitters 74 during the above sealing operation.

The image-forming device shown in FIG. 8 is prepared according to, for example, the procedure below.

The envelope 88 is evacuated through a pipe (not shown) using an oil-free evacuation unit such as an ion pump or a sorption pump while the envelope 88 is heated according to needs, whereby the pressure in the envelope 88 is reduced to 1.3×10⁻⁵ Pa, that is, the content of an organic substance in the atmosphere of the envelope 88 is sufficiently decreased. The resulting envelope 88 is then sealed. In order to maintain the degree of vacuum in the sealed envelope 88, gettering treatment may be performed. In the gettering treatment, just before or after the envelope 88 is sealed, a getter (not shown) placed at a predetermined area in the envelope 88 is heated by a resistance heating method or a high-frequency heating method, whereby a deposition layer is formed on the inner wall of the envelope 88. The getter usually principally contains Ba. The pressure in the envelope 88 can be maintained at, for example, 1.3×10⁻⁵ Pa or less by the adsorption effect of the deposition layer. Steps, following the electroforming step, for manufacturing the electron emitters can be properly selected.

The display panel 101 is connected to external electrical circuits with first terminals Dₒₓ₁ to Dₒₓₘ, second terminals D_{oy1} to D_{oyn}, and high-voltage terminals 87. Scanning signals for driving the electron source placed in the display panel 101 are applied to the first terminals Dₒₓ₁ to Dₒₓₘ. In the electron source, the electron emitters are arranged in a matrix with m rows and n columns and a group of the electron emitters arranged in each row are sequentially driven, the number of the electron emitters arranged in the row being n. Modulating signals for controlling beams of electrons emitted from the electron emitters are applied to the second terminals D_{oy1} to D_{oyn}, the electron emitters being arranged in the row and driven by the scanning signals. A DC voltage of, for example, 10 kV is applied to the high-voltage terminals 87 from a DC power supply. The applied voltage is used to impart energy, having an intensity sufficient to excite the single fluorescent material or color fluorescent materials, to the electron beams, thereby accelerating the electron beams.

In the image-forming device, having the above configuration, according to the present invention, voltages are applied to the electron emitters through the first terminals Dₒₓ₁ to Dₒₓₘ and second terminals D_{oy1} to D_{oyn} extending out of the envelope 88, whereby electrons are emitted from the electron emitters. A high voltage is applied to the metal back 85 or the transparent electrode (not shown) through the high-voltage terminals 87, whereby beams of the electrons are accelerated. The accelerated electrons collide against the fluorescent screen 84, which emits light, whereby an image is formed.

The above-mentioned image-forming device, which is an example of an electro-optical device according to the present invention, can be used as a component of various electronic apparatuses such as display systems for television broadcasting service, display units for television conference systems or computers, and optical printers including a photosensitive drum. Other examples of an electronic apparatus of the present invention will now be described.

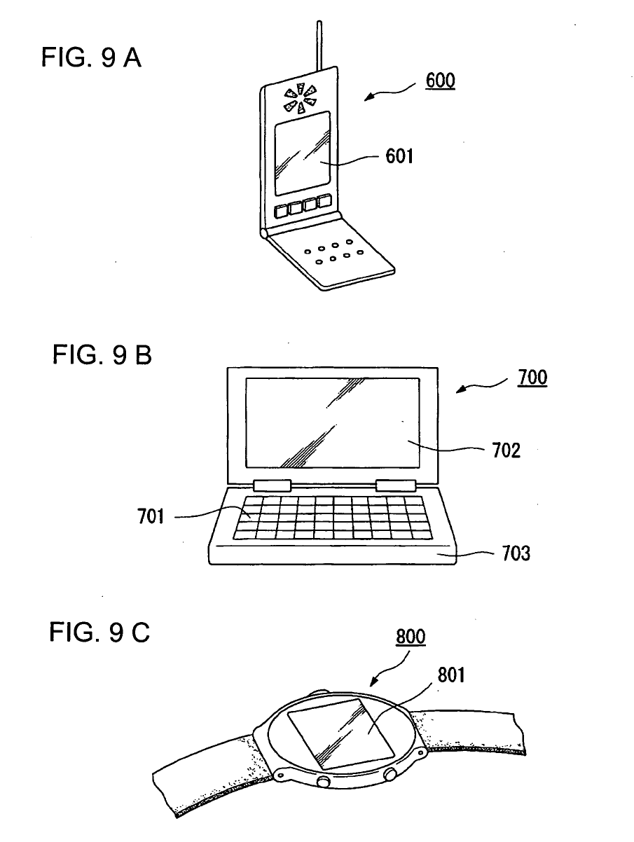

FIG. 9(a) is a perspective view showing an example of a mobile phone. With reference to FIG. 9(a), reference numeral 600 represents a mobile phone body and reference numeral 601 represents a display section including the display panel 101 shown in FIG. 8.

FIG. 9(b) is a perspective view showing an example of a mobile information processor such as a word processor or a personal computer. With reference to FIG. 9(b), reference numeral 700 represents the information processor, reference numeral 701 represents an input section including a keyboard, reference numeral 703 represents an information processor body, and reference numeral 702 represents a display section including the display panel 101 shown in FIG. 8.

FIG. 9(c) is a perspective view showing an example of a wristwatch electronic system. With reference to FIG. 9(c), reference numeral 800 represents a watch body and reference numeral 801 represents a display section including the display panel 101 shown in FIG. 8.

Since the electronic apparatuses shown in FIG. 9(a) to 9(c) include the electron emitters according to the above embodiments, the electronic apparatuses have display properties with high stability and reproducibility.

The preferable embodiments of the present invention are herein disclosed together with the accompanying drawings. The present invention is not limited to these embodiments. Configurations and combinations of the components described above are only examples, and within the scope of the present invention, various modifications and various changes may be performed based on design requirements.

In an embodiment described above, for example, the banks B are removed in the ashing step; however, the present invention is not limited to this embodiment. If the banks B do not affect display properties, the banks B may be allowed to remain. In this case, the ashing step can be eliminated, whereby production efficiency is enhanced.

In an embodiment described above, the electrode-forming regions 2a and 3a and the conductive layers 4 are lyophilized; however, the present invention is not limited to this embodiment. For example, either the electrode-forming regions 2a and 3a or the conductive layers 4 may be lyophilized.

1. A method for manufacturing electron emitters by providing pairs of element electrodes, and conductive layers connecting the element electrodes to each other on a substrate, the method comprising:
a step of forming banks surrounding electrode-forming regions for forming the element electrodes and conductive layer-forming regions for forming the conductive layers;
a step of discharging first droplets toward the electrode-forming regions; and
a step of discharging second droplets toward the conductive layer-forming regions.

2. The method for manufacturing electron emitters according to claim 1, further comprising a step of lyophobing the banks.

3. The method for manufacturing electron emitters according to claim 1, wherein the banks are formed using a lyophobic material.

4. The method for manufacturing electron emitters according to claim 1, further comprising a step of lyophilizing at least one of the electrode-forming region and the conductive layer-forming region.

5. An electron emitter manufactured by the method according to claim 1.

6. An electron emitter comprising:
a substrate;
a pair of element electrodes;
a conductive layer connecting the element electrodes to each other; and
a bank surrounding the element electrodes and the conductive layer,
wherein the element electrodes, the conductive layer, and the bank are disposed on the substrate.

7. An electro-optical device comprising the electron emitter according to claim 6.

8. An electronic apparatus comprising the electro-optical device according to claim 7.

9. A method for manufacturing an electron emitter comprising:
defining a pair of spaced apart electrode-forming regions on a substrate;
defining a conductive layer-forming region on the substrate, the conductive layer-forming region interconnecting the electrode-forming regions;
forming a bank encircling the electrode-forming regions and the conductive-layer-forming region;
discharging first droplets toward the electrode-forming regions to form a pair of element electrodes; and
discharging second droplets toward the conductive layer-forming regions to form a conductive layer connecting the element electrodes to each other.

10. The method of claim 9 further comprising treating a portion of the conductive layer to form an electron-emitting section.

11. The method of claim 9 further comprising removing the bank after the conductive layer and element electrodes are formed.

12. The method of claim 9 further comprising rendering the bank lyophobic.

13. The method of claim 9 further comprising rendering at least one of:
the electrode-forming regions; and
the conductive layer-forming region;
lyophilic.
